(19) United States
(12) Patent Application Publication
(10) Pub. No.: US 2016/0152441 A1
(43) Pub. Date: Jun. 2, 2016

(54) HYDRAULIC BRAKE SYSTEM

(71) Applicant: INVENTIO AG, Hergiswil (CH)

(72) Inventor: Reto Tschuppert, Luzern (CH)

(21) Appl. No.: 14/888,105

(22) PCT Filed: Apr. 28, 2014
(86) PCT No.: PCT/EP2014/058551

§ 371 Date: Oct. 30, 2015

(30) Foreign Application Priority Data
Apr. 30, 2013 (EP) 13166054.0

(51) Int. Cl. B66B 5/18

(52) U.S. Cl. CPC B66B 5/18

(57) ABSTRACT

A hydraulic brake system for a passenger transport installation includes actuation equipment, a pump supplying brake fluid to a piston space of the actuation equipment and a motor driving the pump. A control device controls the motor by a frequency inverter whereby the pump supplies brake fluid at a predetermined delivery flow rate (Q_{P}). A pressure (p_{B}) is set in the piston space corresponding to an equilibrium in which the delivery flow rate (Q_{P}) is equal to a return flow rate (Q_{L}). The control device sets the pressure (p_{B}) by the delivery flow rate (Q_{P}) of the pump. The passenger transport installation can be a lift, an escalator or a moving walkway having this brake system operated according to the described method for controlling the braking force.

### FIELD

The invention relates to a brake system for a passenger transportation system which is embodied as an elevator, escalator, or moving walk, a corresponding passenger transportation system, and a method for controlling the braking force in such a passenger transportation system. The invention especially relates to the field of elevator systems.

### BACKGROUND

From EP 0 648 703 A1 a braking safety device for an elevator car is known. Therein, a braking device is provided which grips on a guiderail, the braking force that is exerted by the braking device on the guiderail being regulated by a regulating device. The braking device embraces a free web of the guiderail, which is provided with running surfaces, there being provided for each running surface a braking plate which is borne by a braking-plate holder. Further, at least one of the braking plates is actuatable by means of a brake cylinder, the brake cylinder being pressurizable with a regulated pressure which is generated in a pressurizing medium by means of a pressurizing device and regulated by means of the regulating device. The pressurizing device that belongs to the safety device has a pressure pump, which is driven by a motor, which pumps pressurizing medium from a tank through a non-return valve to a pressure accumulator, until the maximum accumulated pressure that is set on a second pressure switch is attained. If the accumulated pressure falls below a minimum pressure that is settable on a first pressure switch, the pressure accumulator is reloaded to the maximum accumulated pressure. The accumulated pressure is greater than the braking pressure that is required in the event of a braking. In the event of a braking, a 3/2-way valve and a pressure-regulating valve pressurize the brake cylinder with the pressurizing medium that is conveyed through the pressurizing-medium pipeline. After the braking event, the 3/2-way valve and the pressure-regulating valve return to their starting state, so that the pressurizing medium in the brake cylinder can depressurize through a settable throttle valve to a tank. By this means it is possible that the deceleration of the elevator car remains constant and maintains a predefined value during the entire braking operation. For this purpose, the regulating device compares the predefined value, for example the acceleration due to gravity (1 g), with the value that is measured on the elevator car by means of a deceleration sensor and compensates differences between the two values by means of a greater or lesser pressurization of the brake cylinder by means of the pressure regulating valve. As soon as the elevator car has come to a standstill, the regulating device changes the setting of the pressure regulating valve in such manner that the braking force of the braking cylinder attains its maximum value. The elevator car is thereby blocked in the elevator hoistway.

In a further possible embodiment, which is known from EP 0 648 703 A1, in the hydraulically pressureless state a compression spring presses the brake plates against the running surfaces of the guiderail. By this means, the elevator car is held with maximum braking force on the guiderails. To establish and maintain the operational readiness of the pressurizing device, based on the signals of the first pressure switch and of the second pressure switch, the regulating device that is connected with the elevator control switches the motor on and off. If the accumulated pressure in the pressure accumulator falls below a minimum pressure, which is settable on the first pressure switch, in response to the pressure-switch signal the regulating device switches the motor on. The motor remains switched on until the maximum pressure at the second pressure switch is attained. If the regulating device switches a 2/2-way valve on, pressuring agent flows into the cylinder space, as a result of which the compression spring is compressed. Upon attainment of a maximum braking pressure, the regulating device closes the 2/2-way valve. In this operating state of the pressurizing device, the brake plates are raised from the running surfaces of the guiderail. By increasing and decreasing the braking force of the braking-force cylinder, the deceleration of the elevator car can be held constant, maintaining a predefined value during the entire braking operation.

The braking safety device for an elevator car which is known from EP 0 648 703 A1 has the disadvantage that the actuation of the braking device and the regulation of the braking force are elaborate. In particular, the use of the pressure accumulator and of the regulating valve are costly and elaborate. Additionally necessary for a reliable regulation operation is that the pressure in the pressure accumulator is set and maintained within a pressure range that is as narrow as possible, which calls for a frequent switching on and off of the motor and of the pump as well as precisely operating switching elements and correspondingly frequent maintenance. Further, in the operating mode in which the brake is closed via the pressure in the pressure accumulator, the use of components of the hydraulic system that are as leakproof as possible is necessary, since otherwise the energy consumption for the regular replenishment of the pressure agent, and for the maintenance of the braking pressure, is too great for economical operation. However, also in the operating mode in which the braking force is reduced through the pressure of the pressurizing device, the problem arises that, in order to ensure the operational readiness, the pressure of the pressurizing device must be constantly maintained, which results in a high energy requirement. In particular as a consequence of the large number of components and elements of the hydraulic system that are required, leakage losses occur, and hence a correspondingly high energy consumption and a high maintenance requirement.

Known from EP 1 657 204 A2 are various embodiments for guided lifting systems with holding devices and safety gears, wherein a car can be guided on a guiderail in traveling manner.

### SUMMARY

An object of the invention is to provide a brake system for a passenger transportation system, a passenger transportation system, and a method for controlling the braking force in such a passenger transportation system, which is of simple construction, with good regulability, and with an overall low energy consumption.

In what follows, solutions and proposals for a corresponding brake system, for a passenger transportation system, and a method, are presented, which solve at least parts of the set objective. In addition, advantageous augmentary or alternative further developments and embodiments are presented.

Preferably, the passenger transportation system is embodied as an elevator. The brake system serves to halt an elevator car of the elevator. In corresponding manner, however, a halting of a respective passenger transportation system by the brake system can also take place in the case of an escalator or a moving walk. The explanations that have been given in relation to the elevator and the elevator car therefore also apply in corresponding manner for an escalator or a moving walk. Although the present explanations generally refer to passenger transportation systems, the explanations can self-evidently also be applied to systems for the transportation of freight or goods. This applies particularly to freight elevators or goods lifts.

The brake system is embodied so that a return-flow volume stream is permitted in such manner that a pressure in the piston chamber of an actuating device arises that corresponds to an equilibrium. The equilibrium corresponds to a state in which a discharge volume stream is identical to the return-flow volume stream. In operation, for example when setting a desired braking force, in the event of a variation of the return-flow volume stream a corresponding change of pressure in the direction of the respective resulting equilibrium can occur, which represents a quasi-static case. Practically, an at least asymptotic approximation to the resulting equilibrium takes place. By this means, particularly in a switchover operation, changes of the discharge volume stream as well as of the return-flow volume stream occur, so that the pressure that arises in the piston chamber can also only occur after a short adaptation time. If necessary, however, through suitable control operations, especially regulating operations, a control device can shorten such adaptation times. Furthermore, through a suitable embodiment of the components, the necessary adaptation time for the controlling or regulating operations can be predefined, or set, sufficiently short.

The control device is further so embodied as to set the pressure in the piston chamber of the actuating device at least indirectly via at least the discharge volume stream of the pump. Hence, in a corresponding embodiment, the control device can additionally set the discharge volume stream of the pump in another manner, in particular by a variation of the return-flow volume stream.

It is advantageous for the control device at least indirectly to switch a motor that drives the pump in such manner that the discharge volume stream of the pump is predefined by a predefined rotational speed of the pump and/or by a predefined power of the motor that is predefined by the control device. Alternatively or augmentarily, the control device can switch the motor at least indirectly in such manner that a predefined motor current of the motor is set, whereby a discharge volume stream that corresponds to the motor current is set. In particular if the pump is embodied as a volume pump, especially as a gear pump, the discharge volume stream of the pump can in advantageous manner be set at least approximately via the rotational speed of the pump or the power of the motor. Through a fixed coupling of the rotational speed of the motor with the rotational speed of the pump, which can take place via a common axle or via a gearbox, through the switching of the motor with a certain rotational speed, the discharge volume stream of the pump can be set. The discharge volume stream of the pump can thus be varied and set in simple manner.

Also advantageous is for the control device to switch the motor by means of a frequency converter. By this means, an indirect switching of the motor by the control device is possible, in particular it being possible for the rotational speed of the motor to be predefined.

Also advantageous is for a throttle to be provided and for the throttle to be connected at one side at least indirectly with the at least one piston chamber of the actuating device and/or at least indirectly with a discharge side of the pump. Further advantageous is for the throttle at the other side to be connected at least indirectly with a tank out of which the pump pumps and/or at least indirectly with a suction side of the pump. Through the throttle, the return-flow volume stream is thereby permitted. Depending on the embodiment of the brake system, the throttle can also serve to additionally raise the return-flow volume stream to a system-dependent leakage. It is therefore advantageous for the return-flow volume stream to be at least partially permitted via the throttle.

Further in advantageous manner at least a filter is provided which cleans the brake fluid, in particular an oil, in order to filter soiling and thereby assure a long service life of the brake system. In particular, it is advantageous for the throttle to be connected at one side by means of the filter with the piston chamber of the actuating device and/or by means of the filter with the discharge side of the pump. In addition, or alternatively, it is further advantageous for the throttle at the other side to be connected by means of a filter with the tank and/or by means of a filter with the suction side of the pump. If the filter is arranged, for example, between the tank and the suction side of the pump, a soiled filter does not then hinder the return-flow volume stream. By this means, a related influencing of switching of the braking device can be avoided.

Further advantageous is for the throttle to be embodied in such manner that the return-flow volume stream that is permitted by the throttle, or the part of the return-flow volume stream that is permitted by the throttle, increases at least approximately linearly with the pressure in the piston chamber. For this purpose, it is particularly advantageous for the throttle to have an orifice plate or to be embodied at least essentially by an orifice plate. Such an orifice plate can have a fixed aperture cross-section. By this means, a volume stream that is permitted by the throttle is at least approximately proportional to the pressure in the piston chamber. The term “throttle” is, however, to be understood generally and also includes other embodiments and is not restricted to orifice plates or constrictions.

Also advantageous is for the throttle to be embodied as a settable throttle. In this case, in a possible embodiment, the settable throttle can be set by an authorized person. This can take place, for example, during an installation or mounting of the brake system and, if necessary, be subsequently changed by the authorized person. By this means, an adaptation to the respective application case, and a matching in relation to tolerances, or in relation to the differences in switching behavior that arise from the concrete application case, is possible. The settable throttle can, however, also be embodied to be switchable by the control device of the brake system, in order to vary the throttling action of the throttle within the framework of the control. Such a switchable throttle enables control concepts in which the control device sets the pressure in the piston chamber of the actuating device at least indirectly via the discharge volume stream of the pump as well as the return-flow volume stream, which is settable by the switchable throttle.

Further advantageous is for the pump to be embodied as a pump with a self-leakage and for the return-flow volume stream to be at least partly enabled via the self-leakage of the pump. If the self-leakage of the pump is sufficiently large, a throttle to permit the return-flow volume stream can also be obviated. In particular, an inexpensive pump can be selected, which permits a certain leakage and hence a certain part of the return-flow volume stream. Via the throttle, in particular a settable throttle, the return-flow volume stream can be increased in a desired manner. This results, both in relation to the self-leakage of the pump and to the throttling effect of the throttle, in a desired dependence of the return-flow volume stream on the pressure in the piston chamber of the actuating device.

Preferably, the control device is connected with a sensor, which registers at least a measurement parameter of the brake fluid or of the actuating device. The control device can correspondingly set the discharge volume stream of the pump to set the pressure in the piston chamber of the actuating device taking into account this measurement parameter. By this means, parameters that affect the brake system can be considered or compensated.

Preferably, for example, a sensor in the form of a temperature sensor is used which registers a temperature of the brake fluid. By this means, the control device can at least indirectly set the pressure in the piston chamber of the actuating device at least indirectly, or at least set the discharge volume stream of the pump taking into account the registered temperature of the brake fluid. The temperature of the brake fluid can therefore be taken into account by the control. In particular, a temperature compensation can thus be realized.

In addition, or alternatively, it is advantageous for the control device to be connected with a sensor in the embodiment of a pressure sensor, which registers the pressure in the piston chamber of the actuating device. By this means, the control device can at least indirectly set the pressure in the piston chamber of the actuating device via the discharge volume stream of the pump, taking into account at least the registered pressure in the piston chamber of the actuating device. In this manner, a regulation can also be realized, in which, for example, the rotational speed of the pump can be suitably increased or decreased. However, the registered pressure in the piston chamber can also be used as one of several measurement parameters in order to adapt the braking behavior of the braking device over several switching cycles. By this means, a self-regulation is attainable, in which, for example, soiling of a filter, or changes of the return-flow volume stream that are made necessary through changes of the leakage, or through the ambient temperature, and suchlike, can be compensated in simple manner. In particular, a compensation of changes that occur in the course of time can take place independent of the concrete cause.

Further advantageous is for the control device to be connected with a sensor in the embodiment of a force sensor, which registers an activating force of the activating device which is dependent on the pressure in the piston chamber. By this means, the control device can at least indirectly, via the discharge volume stream of the pump, taking into account at least the registered actuating force of the actuating device, set the pressure in the piston chamber of the actuating device. Also by this means, a regulation can be realized, in which the actuating force is set to a desired target value. Further, corresponding to the registration of the pressure in the piston chamber of the actuating device, a compensation of deviations that occur over the operating life can be achieved also through the registered actuating force. By this means, the control can be improved.

Also advantageous is for the control device to be connected with a sensor in the embodiment of a distance sensor, which registers relative to a piston bore, or variable height of the piston chamber, a displacement distance of an adjustable piston of the actuating device that bounds the piston chamber. Via the registered displacement distance, or the registered height of the piston chamber, an improvement of the control and a regulation of the pressure in the piston chamber that takes into account the displacement distance can be achieved. In particular, via the registered height, a feeding or displacement movement of the piston can rapidly take place and be controlled.

Further, for reasons of redundancy, a plurality of measurement parameters can be registered and taken into account in the control. The accuracy of the control can thereby be improved and the operating safety be increased.

Further advantageous is for the braking device to be embodied as a hydraulically opened braking device. Hereby, the braking force can be supplied by a spring element or similar, while the pressure in the piston chamber is sufficiently low. Hence, the pump need only be switched on when the braking device is open, in other words, when it does not need to brake. In particular in an elevator, as a rule, the elevator car spends most of its time in a halted, or waiting, position. A switched-on time, during which the braking device releases the elevator car, is therefore comparatively small, particularly, in many cases, substantially less than 50%, and in relation to the switched-on time of the elevator system, substantially less than 50%. In view of the energy consumption, it is therefore expedient to use the pressure in the piston chamber of the actuating device, which is produced by the driving of the pump, to release the braking device, in other words, as explained above, to embody the braking device as a hydraulically opened braking device.

Also advantageous is for a pressure-relief device to be provided, which, in the event of an actuation, rapidly reduces the pressure in the piston chamber, and for the control device to be so embodied as to actuate the pressure-release device in a rapid-braking operating mode. Hence, with an opened braking device, in particular an emergency stop can be realized through the pressure-release being actuated in the rapid-braking operating mode. This results in a rapid reduction, or even collapse, of the pressure in the piston chamber of the actuating device and hence to an immediate triggering of the braking device.

It is also advantageous for a pressure-limiting device to be provided, which limits the pressure in the piston chamber. In the case of an opened braking device, the pressure in the piston chamber can thereby be limited to a pressure that is sufficient to reliably open the braking device. In a hydraulically actuated braking device, the maximum possible braking force can be set by the pressure-limiting device. The system is also protected against an overloading, for example on account of blocked pipelines.

In advantageous manner, the pump is embodied as a volume pump. In particular by this means, via a rotational-speed reduction, the desired pressure in the piston chamber can be set. For this purpose, the pump can be embodied as a piston pump or, advantageously, as a gear pump.

For reasons of redundancy, also a plurality of braking devices, a plurality of pumps, and a plurality of control devices can be provided, there being assigned to each braking device a pump and a control device. By this means, on the one had an improved switching of each braking device is possible, since in each case the braking force can be set individually. In particular by this means, differences between the braking forces of the individual braking devices can be avoided. In addition, the operating safety is thereby increased.

### DESCRIPTION OF THE DRAWINGS

Preferred exemplary embodiments of the invention are explained in greater detail in the description that follows below by reference to the attached drawings. Shown are in:

FIG. 1 is a schematic representation of a passenger transportation system, in particular of an elevator with a brake system;

FIG. 2 shows a brake system in a partial, schematic representation corresponding to an exemplary embodiment of the invention; and

FIG. 3 is a volume stream versus pressure diagram explaining the manner of functioning of the brake system.

### DETAILED DESCRIPTION

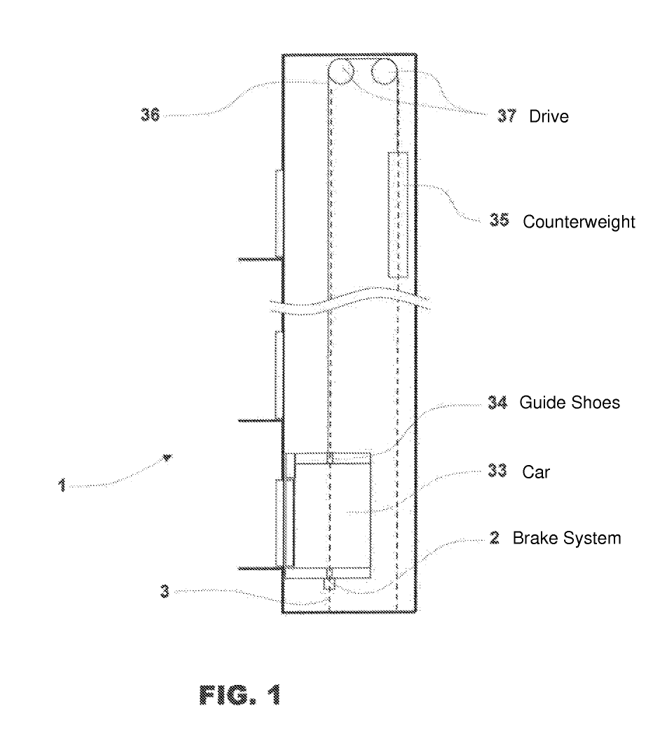

FIG. 1 shows a passenger transportation system 1, which is embodied as an elevator (elevator system) 1, with a brake system 2. In a correspondingly modified embodiment, the passenger transportation system 1 can also be embodied as an escalator or moving walk.

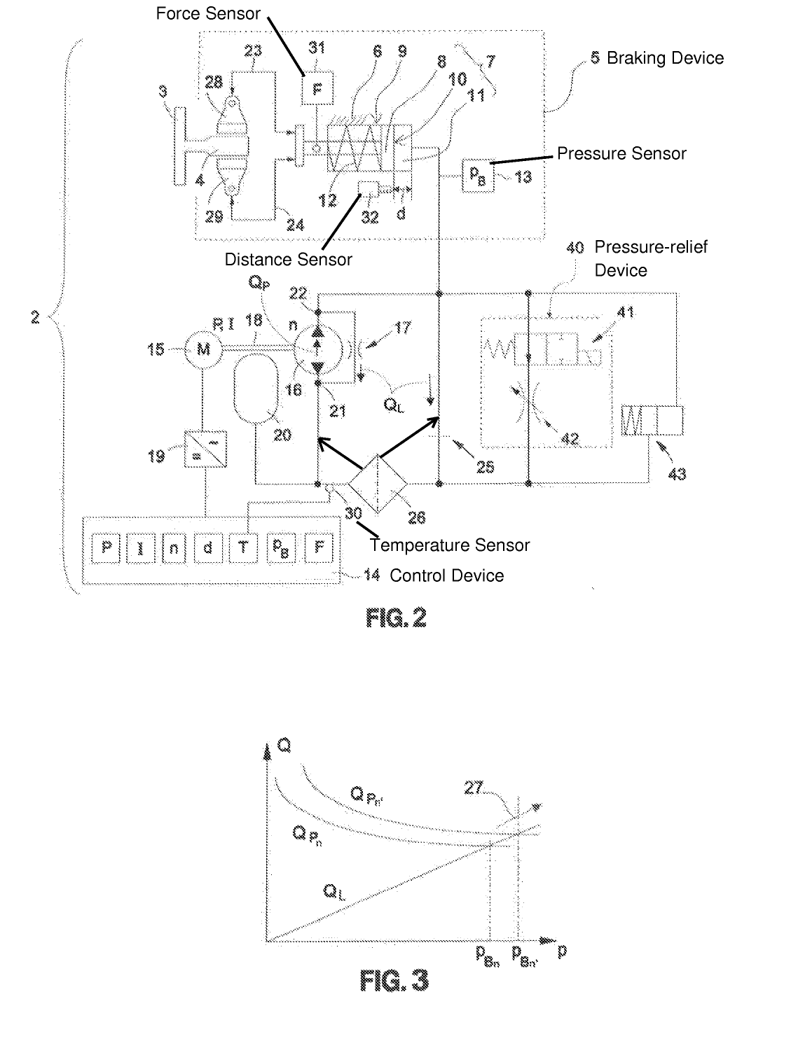

The passenger transportation system 1 has an elevator car 33. The elevator car 33 is suitable for accommodating passengers or goods. In the example, the elevator car 33 is connected by means of suspension means 36 via a drive 37 to a counterweight 35. The elevator car 33 is guided by guide shoes 34 on guiderails 3. The guiderail 3 comprises a rail foot and a guiding and braking web 4 (FIG. 2). The rail foot of the guiderail 3 can, for example, in an elevator hoistway of the elevator 1 be joined with a wall of the elevator hoistway or with a suitable supporting structure. By this means, the brake system 2 is assigned to the braking web 4 of the guiderail 3. As a rule, in such a passenger transportation system 1, a pair of guiderails 3 is used, one guiderail respectively being arranged on each side of the elevator car. Correspondingly, arranged in the elevator car 33 are two brake systems 2, each of which is assigned to one of the guiderails. Further brake systems can also be provided, which are also assigned to the braking web 4 and/or to at least one further braking web. Hence, the elevator 1 has at least one brake system 2.

FIG. 2 shows a brake system 2 which can be used, for example, for the elevator that is described above. The brake system 2 has a braking device 5 with a housing 6 and an actuating device 7, wherein the actuating device 7 has a piston 8 which is guided in a piston bore 9 of the housing 6. In the piston bore 9, an end-face 10 of the piston 8 bounds a piston chamber 11, whereby the volume of the piston chamber 11 depends on a displacement distance d of the piston 8 in the piston bore 9. The displacement distance d thus matches a height d of the piston chamber 11. The volume of the piston chamber 11 is thus proportional to the displacement distance d, or the height d, of the piston chamber 11.

The piston bore 9 is preferably embodied cylindrically as a cylinder bore in which the displaceable piston 8 is movable. Hence, the displacement of the piston 8 relative to the piston bore 9 is relevant. In the event of a displacement, either the piston 8 or the piston bore 9 can be arranged locationally fixed. Also an arrangement in which both the piston 8 and the piston bore 9 can move is possible.

In addition, the braking device 5 has a spring element 12. The spring element 12 counteracts an enlargement of the volume of the piston chamber 11 and hence an enlargement of the height d. In operation, in the piston chamber 11 is a brake fluid that is under a pressure p_{B}. Hence, the force of the spring element 12 acts against the pressure p_{B} in the piston chamber 11.

Provided in this exemplary embodiment is a pressure sensor 13, which measures the pressure p_{B} in the piston chamber 11. Also provided is a control device 14 which in suitable manner is connected with the pressure sensor 13.

The brake system 2 further has a motor 15 and a pump 16 with changeable direction of rotation, or changeable direction of pumping, or at least with a changeable discharge volume stream Q_{P}. The pump 16 can have a self-leakage 17, which in FIG. 2 is shown as a throttled auxiliary pipeline. However, in a modified embodiment, the pump 16 can also be embodied as at least essentially leakage-free. The pump 16 is preferably embodied as a volume pump, particularly as a gear pump. The pump 16 is driven by the motor 15 via a common axle 18. In a modified embodiment, the pump 16 can also be driven by the motor 15 through a gearbox.

At least indirectly, the control device 14 switches the motor. In this exemplary embodiment, the control device 14 controls the motor 15 by means of a frequency converter 19. Further, the brake system 2 has a tank 20, from which the pump 16 pumps the brake fluid into the piston chamber 11. The tank 20 is connected with a suction side 21 of the pump 16. The piston chamber 11 is connected with a discharge side 22 of the pump 16.

Also provided is a throttle 25, which at one end is connected with the piston chamber 11 of the actuating device 7 and with the discharge side 22 of the pump 16. At its other end, the throttle 25 is connected via a filter 26 with the suction side 21 of the pump 16 and with the tank 20, out of which the pump 16 pumps. Hence, the filter 26 is connected at one end with the throttle 25 and at the other end both with the tank 20 and with the suction side 21 of the pump 16.

In this exemplary embodiment, the throttle 25 is embodied at least essentially by an orifice plate. Depending on the pressure p_{B} in the piston chamber 11, a return-flow volume stream Q_{L} arises. In this exemplary embodiment, this return-flow volume stream Q_{L} divides itself between the self-leakage 17 and the throttle 25. Further, depending on a rotational speed n of the pump 16, the discharge volume stream Q_{P} of the pump 16 results. In this respect, the rotational speed n can be predefined by the control device 14. However, the rotational speed n of the pump 16 can also result in relation to a predefined power P of the motor 15 or its motor current I, wherein the power P or the motor current I can be varied by the control device 14.

There follows a more detailed explanation of the embodiment and manner of functioning of the brake system 2 by reference to FIG. 3.

FIG. 3 shows a diagram which explains the manner of functioning of the brake system 2 of FIG. 2. Shown there on the abscissa is a pressure p. Shown on the ordinate is a volume stream Q. Shown in the diagram are three curves Q_{L}, Q_{Pn}, Q_{Pn′}. Shown for the return-flow volume stream Q_{L} is a linear dependency on the pressure p. The return-flow volume stream Q_{L} that occurs via the self-leakage 17 and the throttle 25 is therefore proportional to the pressure p. Further, at constant rotational speed n, with increasing pressure p, the discharge volume stream Q_{P} decreases. Therefore, in the diagram, two curves with discharge volume streams Q_{Pn}, Q_{Pn′} are shown, a first curve representing a discharge volume stream Q_{Pn} at a first rotational speed n and a second curve representing a discharge volume stream Q_{Pn′} at a second rotational speed n′. The rotational speed n′ is greater than the rotational speed n of the pump.

In quasi-static equilibrium, the return-flow volume stream Q_{L} is always—depending on the rotational speed n—equal to the discharge volume stream Q_{Pn}, Q_{Pn′}. Hence, in the piston chamber 11 of the actuating device 7, the pressure P_{Bn}, P_{Bn′} that corresponds to the rotational speed n, n′ arises, as is depicted in FIG. 3. Hence, the equilibrium is a stable equilibrium. If, for example, in equilibrium, the pressure p were less than the pressure p_{B}, this would initially result in a smaller return-flow volume stream Q_{L} than the discharge volume stream Q_{P}. This means, however, that more brake fluid is pumped into the piston chamber 11 than flows out of it. This results in a pressure increase in the piston chamber 11, as well as in an increase in the volume of the piston chamber 11, which results in an increase in the displacement distance d or in the height d. Taking into account the spring force of the spring element 12 that hereby also increases, an increase in the pressure in the piston chamber 11 continues until the pressure p_{B} is attained which is shown in FIG. 2.

It should be noted that the dependency of the discharge volume stream Q_{P} on the pressure p in the piston chamber 11 always applies for a certain rotational speed n or a certain power P or a certain motor current I. In the event of a change of the rotational speed n of the pump 16, or of the power P, or of the motor current I, of the motor 15, there results another association which can be at least approximately described by a displacement of the entire curve in a direction 27 or opposite to the direction 27. Therein, a displacement of the curve Q_{P} in the direction 27 is achieved through an increase of the rotational speed n or an increase of the power P or of the motor current I. Correspondingly, a reduction of the rotational speed n or a reduction of the power P or of the motor current I results in a displacement opposite to the direction 27. In FIG. 3, for example, discharge volume streams Q_{Pn}, Q_{Pn′} at two different rotational speeds n, n′ are shown. Self-evidently, in a rotational-speed regulated pump, there is an array of discharge volume streams, wherein for each rotational speed n there is an associated equilibrium-point discharge volume stream Q_{P} that equals the return-flow volume stream Q_{L}.

To change the pressure p_{B} in the piston chamber 11, the control device 14 changes the rotational speed n, the power P, or the motor current I. Through the change in the entire curve Q_{P} that is brought about in this manner, a new equilibrium results, in which the return-flow volume stream Q_{L} is equal to the discharge volume stream Q_{P}, which corresponds to a changed intersection between the curves Q_{L}, Q_{P}. Hence, in equilibrium, a new pressure p_{B} arises in the piston chamber 11.

Hence, the control device 14 can set the pressure p_{B} in the piston chamber 11 of the actuating device 7 via the discharge volume stream Q_{P} or via the rotational speed n of the pump 16. In a modified embodiment, the throttle 25 can be embodied as a settable throttle 25, whereby a stability is enabled by the control device 14. The control device 14 can then additionally set the pressure p_{B} also via the return-flow volume stream Q_{L}. Since, through a change in the throttle action of the throttle 25, in particular of an aperture cross-section of the orifice plate 25, the gradient of the curve Q_{L} can be varied. For an inexpensive and simple embodiment of the brake system 2, it is, however, also advantageous for the control device 14 to set the pressure p_{B} in the piston chamber 11 of the actuating device 7 at least indirectly via only the discharge volume stream Q_{P} of the pump 16.

Depending on the pressure p_{B} in the piston chamber 11, a displacement of the actuating device 7 takes place. The actuating device 7 acts on brake shoes 28, 29 of the braking device 5 as indicated by the double arrows 23, 24 in FIG. 2. Hence, the braking device 5 can be embodied as a hydraulically actuated or hydraulically opened braking device 5. In an embodiment as a hydraulically actuated braking device 5, an increase in pressure of the pressure p_{B} in the piston chamber 11 results initially in a laying of the brake shoes 28, 29 against the brake rail 4 and then in an increase of the braking force. In an embodiment as a hydraulically opened braking device 5, the maximum braking force of the spring element 12 is attained and, by means of an increasing pressure p_{B} in the piston chamber 11, is gradually reduced.

Also in this exemplary embodiment, a temperature sensor 30 is provided, which is arranged in the return flow after the filter 26. Via the temperature sensor 30, a temperature T of the brake fluid is registered. The temperature sensor 30 can also be situated at a different point. The control device 14 is connected with the temperature sensor 30. Further provided is a force sensor 31, which registers an actuating force F of the actuating device 7 which is registered by the pressure p_{B} in the piston chamber 11. The pressure sensor 31 is connected in suitable manner with the control device 14. Further provided is a distance sensor 32 which registers the displacement distance d of the piston 8 or the height d of the piston chamber 11. The distance sensor 32 is connected in suitable manner with the control device 14.

When switching the pump 16, the control device 14 can take account of the registered measurement parameters of the sensors, namely the displacement distance d, the temperature T, the pressure p_{B} and the force F. Depending on the embodiment, one or more of these parameters d, T, p_{B}, F can be used, whereby sensors 13, 30, 31, 32 that are not required can also be obviated. Also possible in a particularly simple embodiment of the brake system 2 is a control, which is independent of such registered parameters d, T, p_{B}, F, so that also an embodiment without such sensors 13, 30, 31, 32 is possible.

Through one or more of the registered measurement parameters d, T, p_{B}, F, an improved control, in particular a regulation, is possible. For example, via the temperature T a temperature compensation of the switching of the pump 16 can take place. Further, through at least one of the measurement parameters d, p_{B}, F, a response can be made at least indirectly to the momentary pressure p_{B} in the piston chamber 11. This makes, in particular, a regulation possible, in which the desired braking force can be set and maintained largely independent of such influencing factors.

If the self-leakage 17 of the pump 16, which is represented by the throttled auxiliary pipeline, is sufficiently large, the throttle 25 can also be obviated if necessary. In this embodiment, the return-flow volume stream then arises essentially only through the self-leakage 17 of the pump 16.

Optionally, the brake system 2 can also have a pressure-relief device 40 with a switching valve 41 and a settable throttle 42. If the braking device 5 is embodied as a hydraulically opened braking device 5, through actuation of the switching valve 41 the pressure p_{B} in the piston chamber 11 can be rapidly reduced. This results in a rapid volume decrease in the piston chamber 11, so that the braking force can be built up again correspondingly rapidly. In a correspondingly weak throttling action of the settable throttle 42, a collapse of the pressure in the piston chamber 11 can also result, which enables an emergency braking. By this means, a rapid-braking operating mode is made possible via the pressure-relief device 40.

Further, the brake system 2 can optionally also have a pressure-limiting valve 43. If the braking device 5 is embodied as a hydraulically opened braking device 5, via the pressure-limiting valve 43 the pressure p_{B} can, for example, be limited to a value at which the braking device 5 is opened. If the braking device 5 is embodied as a hydraulically opened braking device 5, through the pressure-limiting valve 43 the maximum braking force can be set.

The hydraulically opened braking device 5 is particularly suitable for passenger transportation systems 1 that are embodied as an elevator. By this means, the brake control 5 can be held open during a travel of the elevator car 33. For example, in the case of an elevator, as a rule an elevator travel takes a maximum of approximately 30 to 45 seconds. Many travels are in fact even shorter, since intermediate stories are travelled to. During a stop, the braking device 5 is then closed, in that the hydraulic brake-opening takes place by switching the piston chamber 11 to pressure-free. At a stop, the pump can be switched off. By this means, heating of the brake fluid is avoided and energy consumption is kept low.

In addition, the brake system 2 can contain a cooling of the brake fluid. For example, the brake fluid in the tank 20 can be cooled. Further, cooling by a pass-through cooler is possible. Further, a rapid reduction of the pressure p_{B} in the piston chamber 11 can also be achieved, or accelerated, by reversing the pumping direction of the pump 16. By this means, the pump 16 pumps the brake fluid back into the tank 20. Provided that the braking device 5 acts without external leakage, the brake fluid is pumped backwards and forwards between the piston chamber 11 and the tank 20, while, in parallel, the return-flow volume stream Q_{L} takes place via the throttle 25.

The speed of the actuating device 7, in other words the time derivative of the displacement distance d, results from the resulting volume stream, which flows into, or out of, the piston chamber 11. Hence, the speed is given by the division of the resulting volume stream by the area of the end-face 10. The integral of the speed over a certain period of time gives the part of the displacement distance d that was travelled in this period of time. If the displacement distance d, or the volume of the piston chamber 11, initially disappears, the integral results in the speed of the displacement distance d. From the displacement distance d results indirectly the pressure p_{B} in the piston chamber 11. From the displacement distance d, the control device 14 can, for example, calculate the pressure p_{B} during a feeding operation. It must, however, be taken into account that also certain effects in the brake system 2 depend on the pressure p_{B} in the piston chamber 11. In particular, the return-flow volume stream Q_{L} is dependent on the pressure p_{B} in the piston chamber 11. In particular, the return-flow volume stream Q_{L} is dependent on the pressure p_{B} in the piston chamber 11 and the motor speed is directly associated with the rotational speed n of the pump 16. Through control of the power P or of the motor current I of the motor 15 and of the rotational speed n, the curve Q_{P} that is depicted in FIG. 3 can be shifted so that the point of intersection with the return-flow volume stream Q_{L} is shifted to the right or to the left. This results in a shift of the pressure p_{B} in the piston chamber 11, whereby a regulation of the pressure p_{B} is made possible. As soon as a required displacement distance of the actuating device 7 has been travelled through, the pressure p_{B} in the piston chamber influences a press-on force with which the brake linings of the braking device 5 are pressed onto the braking rail 4. A regulation of a braking force is thereby made possible.

In advantageous manner, the individual components of the brake system 2 can be assembled into a unit. Hereby, the optimal embodiment of the orifice plate 25 can be determined by trial or calculation. The orifice plate 25 can also be formed by one or more drilled holes in the housing 6 of the braking device 5. Through the pressure-release device 40, a required closing time can be assured. An improved setting of the relief channel that is formed by the pressure-release device 40 can be realized through the settable throttle 42. In a modified embodiment, however, the settable throttle 42 can also be embodied as a fixed throttle. The pressure-limiting valve 43 further assures a protection of the brake system 2 against overloading, since hereby a maximum pressure in the hydraulic circuit of the brake system 2 is limited.

An advantageous regulation of the rotational speed of the pump 16 is possible via the frequency converter 19.

In a modified embodiment, the filter 26 can also be situated in a different position (see arrows in FIG. 2). In particular, the filter 26 can be arranged between the tank 20 and the suction side 21 of the pump 16. By this means, a soiled filter 26 does not hinder a switching of the braking device 5.

Hence, an inexpensive embodiment of the brake system 2 is possible, since the number of parts that is required is small. In particular, valves and correspondingly also valve logic can be saved. In particular, an embodiment of the brake system 2 is possible which is essentially based on the pump 16, the tank 20, the housing 6—which forms a cylinder with the piston bore 9—and the piston 8. Further, a pump 16 with greater self-leakage can be used. By this means, the quality requirements for the pump 16 can be reduced. As a rule, a pump with greater self-leakage is less expensive than a pump with less leakage.

An energy-saving embodiment is also possible, since, during operation of the passenger transportation system 1, in particular of the elevator 1, the rotational speed n of the pump 16, and hence the power, are small. This results in the further advantage that, for example, in an elevator 1 the pump 16 need only be actuated to release the braking device 5. Furthermore, a cooling of the brake fluid, in particular of an oil, can be reduced, or even entirely obviated.

Further, the brake system 2 can be embodied as an integrated unit in which all, or at least most, of the components are integrated into a housing 6 that serves as a brake housing. Through an integrated embodiment, a loss of brake fluid, in particular a leakage loss, to the outside can be minimized.

Hence, the manner of functioning of the brake system 2 can therefore in particular be realized via a rotational-speed regulation of the rotational speed n of the pump 16.

The invention is not restricted to the exemplary embodiments that are described.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A brake system for a passenger transportation system comprising:
a braking device having an actuating device with a piston chamber;
a pump that pumps a brake fluid to the piston chamber;
a control device that sets a pressure in the piston chamber; and
a return-flow volume stream of the brake fluid from a discharge side of the pump, the control device setting the pressure in the piston chamber directly or indirectly based upon a discharge volume stream of the brake fluid from the discharge side of the pump, whereby the pressure in the piston chamber arises corresponding to an equilibrium in which the discharge volume stream is equal to the return-flow volume stream.

17. The brake system according to claim 16 wherein the pump is driven by a motor, and the control device directly or indirectly switches the motor whereby the discharge volume stream is predefined by at least one of a predefined rotational speed of the pump, a predefined power of the motor and a predefined motor current of the motor.

18. The brake system according to claim 16 including a throttle having one end directly or indirectly connected with at least one of the piston chamber and the discharge side of the pump, and the throttle having another end directly or indirectly connected with at least one of a tank out of which the pump pumps the brake fluid and a suction side of the pump, and wherein the return-flow volume stream at least partly flows through the throttle.

19. The brake system according to claim 18 including a filter, the filter being connected between the throttle and at least one of the piston chamber, the discharge side of the pump, the tank and the suction side of the pump.

20. The brake system according to claim 18 wherein a volume of the return-flow volume stream that flows through the throttle is in an approximately linear relationship with the pressure in the piston chamber.

21. The brake system according to claim 18 wherein the throttle is at least one of a settable throttle through which a throttling effect of the throttle is controlled, an orifice plate through which a throttling effect of the throttle is controlled, and is integrated in a housing of the braking device in which the piston chamber is formed.

22. The brake system according to claim 16 wherein the pump has a self-leakage and the return-flow volume stream is at least partly provided by the self-leakage of the pump.

23. The brake system according to claim 16 wherein the control device is connected with at least one sensor that registers a measurement parameter of the brake fluid or the actuating device, the control device setting the pressure in the piston chamber via the discharge volume stream of the pump based upon the measurement parameter.

24. The brake system according to claim 23 wherein the at least one sensor is one of a temperature sensor that registers a temperature of the brake fluid as the measurement parameter, a pressure sensor that registers the pressure of the brake fluid in the piston chamber as the measurement parameter, a force sensor that registers an actuating force of the actuating device as the measurement parameter, and a distance sensor that registers a displacement distance relative to a piston bore of a displaceable piston in the piston chamber or a variable height of the piston chamber.

25. The brake system according to claim 16 wherein at least one of the braking device is a hydraulically opened braking device, and a pressure-relief device is connected to the actuating device and actuated for reducing the pressure in the piston chamber and the control device actuates the pressure-relief device in a rapid-braking operating mode.

26. The brake system according to claim 16 including a pressure-limiting device connected to the actuating device for limiting the pressure in the piston chamber.

27. The brake system according to claim 16 wherein the pump is a volume pump.

28. The brake system according to claim 16 wherein the pump is a gear pump.

29. A passenger transportation system being one of an elevator, an escalator and a moving walk, the passenger transportation system including the brake system according to claim 16.

30. The passenger transportation system according to claim 29 including at least two of the brake system.

31. A method for controlling a braking force in a passenger transportation system, the system including a pump pumping brake fluid to a piston chamber of an actuating device of a braking device and a control device setting a pressure in the piston chamber, comprising the steps of:
permitting a return-flow volume stream of the brake fluid from a discharge side of the pump;
setting the pressure in the piston chamber according to a discharge volume stream of the brake fluid from the discharge side of the pump; and
wherein the brake fluid is pumped by the pump with the discharge volume stream predefined by the control device so that the pressure in the piston chamber corresponds to an equilibrium in which the discharge volume stream is equal to the return-flow volume stream.
